(19) United States
(12) Patent Application Publication
(10) Pub. No.: US 2023/0077933 A1
(43) Pub. Date: Mar. 16, 2023

(54) SUPPORTING PROCESSING-IN-MEMORY EXECUTION IN A MULTIPROCESSING ENVIRONMENT

(71) Applicant: ADVANCED MICRO DEVICES, INC., Santa Clara, CA (US)

(72) Inventors: JOHN KALAMATIANOS, BOXBOROUGH, MA (US); NUWAN JAYASENA, SANTA CLARA, CA (US)

(21) Appl. No.: 17/474,372

(22) Filed: Sep. 14, 2021

(51) Int. Cl. G06F 9/50; G06F 9/46

(52) U.S. Cl. CPC G06F 9/5016; G06F 9/468; G06F 2209/5014; G06F 2209/509; G06F 2209/503

(57) ABSTRACT

A processor for supporting PIM (Processing-in-Memory) execution in a multiprocessing environment includes logic configured to: receive a request to initiate an offload of a number of PIM instructions to a PIM device. The request is issued by a first thread of a processor. The logic is also configured to reserve, based on information in the request, resources of the PIM device for execution of the plurality of instructions.

### BACKGROUND

Computing systems often include a number of processing resources, such as processors or processor cores, which can retrieve instructions, execute instructions, and store the results of executed instructions to memory. A processing resource can include a number of functional units such as arithmetic logic units (ALUs), floating point units (FPUs), and combinatorial logic blocks, among others. Typically, such functional units are local to the processing resources. That is, functional units tend to be implemented as part of a processor and are separate from memory devices in which data to be operated upon is retrieved and data forming the results of operations is stored. Such data can be accessed via a bus between the processing resources and memory. To reduce the number of accesses to fetch or store data in memory—specifically in main memory—computing systems employ a cache hierarchy that temporarily stores recently accessed or modified data in a memory device that is quicker and more power efficient to access than main memory. Such cache memory is sometimes referred to as being ‘closer’ to the processor or processor core.

Processing performance can be improved by offloading operations that would normally be executed in the functional units to a processing-in-memory (PIM) device. PIM refers to an integration of compute and memory for execution of instructions that would otherwise be executed by a computer system's primary processor or processor cores. PIM devices incorporate both memory and functional units in a single component or chip. Although PIM is often implemented as processing that is incorporated ‘in’ memory, this specification does not limit PIM so. Instead, PIM may also include so-called processing-near-memory implementations and other accelerator architectures. That is, the term ‘PIM’ as used in this specification refers to any integration—whether in a single chip or separate chips—of compute and memory for execution of instructions that would otherwise be executed by a computer system's primary processor or processor core. In this way, instructions executed in a PIM architecture are executed ‘closer’ to the memory accessed in executing the instruction. In this way, a PIM device can save time by reducing or eliminating external communications and can also conserve power that would otherwise be necessary to process memory communications between the processor and the memory. To that end, there would be a performance and power consumption improvement in systems in which multithreaded applications can dispatch work to PIM devices.

### BRIEF DESCRIPTION OF THE DRAWINGS

FIG. 1 sets forth a block diagram of an example system for supporting PIM execution in a multiprocessing environment in accordance with the present disclosure.

FIG. 2 sets forth a block diagram of another example system for supporting multiprocessing and forward progress guarantees for offloaded operations in accordance with the present disclosure.

FIG. 3A sets forth a block diagram of an example implementation of a system for supporting PIM execution in a multiprocessing environment according to implementations of the present disclosure.

FIG. 3B sets forth a block diagram of another example implementation of a system for supporting PIM execution in a multiprocessing environment according to implementations of the present disclosure.

FIG. 4 sets forth a flow chart illustrating an example method for supporting PIM execution in a multiprocessing environment according to implementations of the present disclosure.

FIG. 5 sets forth a method of supporting PIM execution in a multiprocessing environment in which multiple threads are executing concurrently according to implementations of the present disclosure.

FIG. 6 sets forth a flow chart illustrating the reservation of several different types of PIM resources according to implementations of the present disclosure.

### DETAILED DESCRIPTION

PIM architectures support offloading instructions for execution in or near memory, such that bandwidth on the data link between the processor and the memory is conserved and power consumption of the processor is reduced. Multithreaded applications would benefit from such execution of instructions by a PIM device. However, there are difficulties in implementing multithreaded application support for PIM execution.

Multithreaded applications executing in PIM require the sharing of limited PIM resources among the threads running PIM code simultaneously. In addition, forward progress of PIM instructions needs to be guaranteed. If a mechanism reserves PIM resources, future PIM instructions may be delayed or eventually deadlocked in a situation where 1) all of the PIM resources are utilized, 2) a PIM resource request waits at the head of a memory controller dispatch queue and cannot be serviced because all of the resources are utilized, and 3) PIM instructions that release the resources arrived after the PIM resource request is unable to progress to the head of the queue. In that way, one thread can be denied access to a PIM device unless all resources needed to execute the thread's PIM code are available. To that end, providing enough space to hold all PIM architectural registers for every hardware context in a multicore processor can result in a significant space and power overhead for a memory device or accelerator implementing PIM logic. Additionally, resource sharing or virtualization within the PIM device can be a difficult task.

To that end, various implementations of methods, processors, and systems for supporting PIM execution in a multiprocessing environment are described in this specification. A method for supporting PIM execution in such a multiprocessing environment includes receiving a request to initiate an offload of a plurality of PIM instructions to an PIM device. The request is issued by a first thread of a processor. The method also includes reserving, based on information in the request, resources of the PIM device for execution of the plurality of PIM instructions.

In an implementation, the method also includes receiving a command, issued by the first thread, indicating that the offload of the plurality of PIM instructions has completed. The method also includes freeing the reserved resources of the PIM device in response to receiving the command.

An implementation of supporting PIM execution in a multiprocessing environment also includes determining an availability of resources of the PIM device to support execution of the PIM instructions. Based on the availability, the method includes providing, to the first thread, a grant response indicating that access to the PIM device by the first thread is granted. Such methods also include issuing, by the first thread, the request to initiate the offload of the plurality of PIM instructions and dispatching, by the first thread, the plurality of PIM instructions to the PIM device only after the grant response is received. In an implementation, the first thread dispatches the plurality of PIM instructions to a set of memory channels concurrently with at least one second thread dispatching PIM instructions to that set of memory channels. Also, in an implementation, the first thread dispatches the plurality of PIM instructions to a first partition of memory channels concurrently with at least one second thread dispatching PIM instructions to a second partition of memory channels.

In an implementation, a method also includes receiving a second request to initiate an offload of a second plurality of PIM instructions to the PIM device. The second request is issued by a second thread. Such a method also includes queuing, based on insufficient available resources, the second request until sufficient resources of the PIM device become available.

In an implementation, reserving resources of the PIM devices includes reserving an allocation of registers based on information in the request. In an implementation, reserving resources includes reserving a command buffer allocation based on information in the request. In an implementation, reserving resources includes reserving a scratchpad allocation based on information in the request. In an implementation, reserving resources of the PIM device includes mapping an index of an architectural register to an index of a physical register of the PIM device.

Implementations of a processor configured for supporting PIM execution in a multiprocessing environment are also described in this specification. Such a processor includes logic configured to receive a request to initiate an offload of a plurality of PIM instructions to a PIM device, the request issued by a first thread of a processor; and reserve, based on information in the request, resources of the PIM device for execution of the plurality of instructions.

In an implementation, the processor also includes comprising logic configured to: determine an availability of resources of the PIM device to support execution of the PIM instructions; and provide, to the first thread based on the availability of resources, a grant response indicating that access to the PIM device by the first thread is granted. In such implementations, the processor can also include logic configured to: receive a second request to initiate an offload of a second plurality of PIM instructions to the PIM device, the second request issued by a second thread; and queue, based on insufficient available resources, the second request until sufficient resources of the PIM device become available.

The processor in an implementations, also includes logic configured to issue, by the first thread, issue, by the first thread, the request to initiate the offload of PIM instructions; and dispatch, by the first thread, the PIM instructions to the PIM device only after the grant response is received.

Also set forth in this specification are variations of systems for supporting PIM execution in a multiprocessing environment. Such systems include a memory device, where the memory device includes a PIM device for executing PIM instructions. Such systems also include a multicore processor coupled to the memory device. The processor includes logic configured to: receive a request to initiate an offload of a plurality of PIM instructions to the PIM device. The request is issued by a first thread of the processor. The processor also includes logic to reserve, based on information in the request, resources of the PIM device for execution of the plurality of PIM instructions.

In an implementation, the processor also includes logic configured to: determine an availability of resources of the PIM device to support execution of the PIM instructions; and provide, to the first thread based on the availability of resources, a grant response indicating that access to the PIM device by the first thread is granted.

In an implementation, the processor also comprises logic configured to: receive a second request to initiate an offload of a second plurality of PIM instructions to the PIM device, the second request issued by a second thread of the processor; and queue, based on insufficient available resources, the second request until sufficient resources of the PIM device become available. In an implementation, the processor also includes logic configured to: issue, by the first thread, the request to initiate the offload of the plurality of PIM instructions; and dispatch, by the first thread, the plurality of PIM instructions to the PIM device only after the grant response is received.

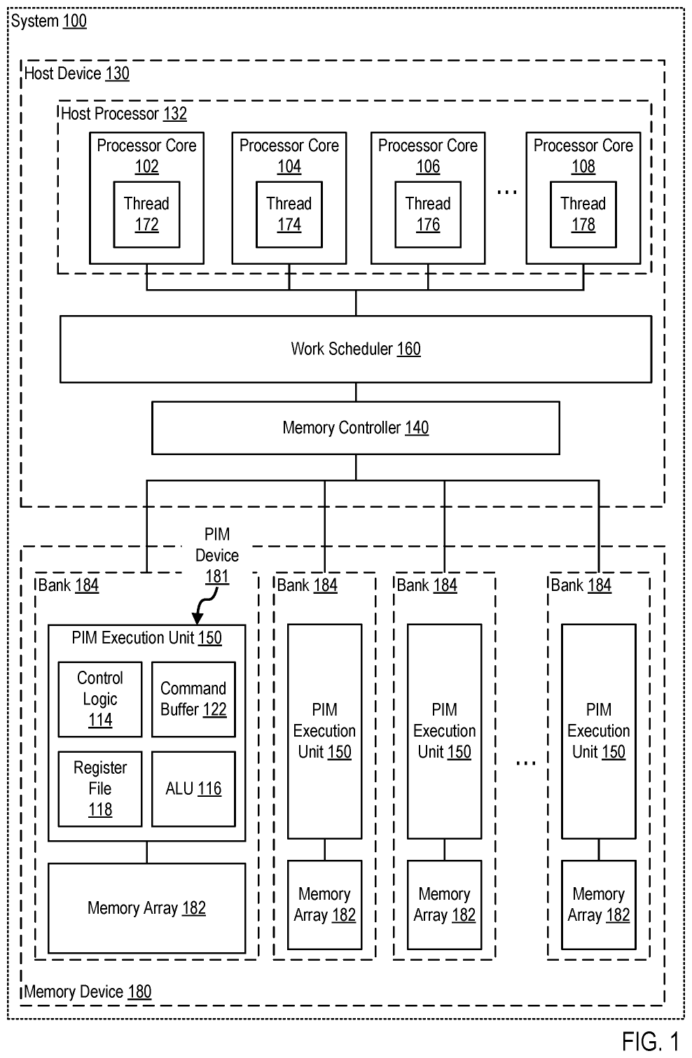

Implementations in accordance with the present disclosure will be described in further detail with references to the figures, beginning with FIG. 1. In the figures, like reference numerals refer to like elements throughout the specification and drawings. FIG. 1 sets forth a block diagram of an example system 100 for supporting PIM execution in a multiprocessing environment in accordance with the present disclosure. The example system 100 of FIG. 1 includes a host device 130 and a memory device 180. The host device 130 includes a host processor 132 that includes one or more processor cores 102, 104, 106, 108. While only four processor cores are depicted in FIG. 1, it should be understood that the host device 130 can include any number of processor cores and, in fact, any number of processors. In various implementations, the processor cores 102, 104, 106, 108 are CPU (Central Processing Unit) cores or GPU (Graphics Processing Unit) cores of the host device 130.

The host processor 132 is configured to execute single-threaded or multithreaded applications. For example, the host processor 132 can execute a single application in multiple threads such that each processor core 102, 104, 106, 108 executes a separate one of the threads 172, 174, 176, 178 in parallel. In an implementation, the host processor 132 can execute multiple threads, where each thread is part of a different single-threaded application. In such an implementation, each processor core 102, 104, 106, 108 executes a thread 172, 174, 176, 178 of a different application.

The processor cores 102, 104, 106, 108 implement an instruction set architecture (ISA) that includes PIM instructions for execution on a PIM device. A PIM instruction is considered ‘completed’ by any of the processor cores 102, 104, 106, 108 when, for example, virtual and physical memory addresses associated with the PIM instruction are generated, operand values in processor registers become available, and memory consistency checks have completed. The operation (e.g., load, store, add, multiply) indicated in the PIM instruction is not executed on a processor core. Instead, the operation of the PIM instruction is offloaded for execution to the PIM device 181. Once the PIM instruction is complete in the core, the core 102, 104, 106, 108 generates and issues a request to initiate the offload of a PIM instruction. The request can include the operation of the PIM instruction, operand values, memory addresses, and other metadata useful in execution of the PIM instruction. In this way, the workload on the processor cores 102, 104, 106, 108 is alleviated by offloading a PIM instruction for execution on a device external to or remote from the processor cores 102, 104, 106, 108, namely a PIM device 181.

The PIM instructions are executed by at least one execution unit 150 of a PIM device 181 that is external to the processor 132 and processor cores 102, 104, 106, 108. In one example, the execution unit 150 includes control logic 114 for decoding instructions or commands issued from the processor cores 102, 104, 106, 108. The execution unit 150 also includes an arithmetic logic unit (ALU) 116 that performs an operation indicated in the PIM instruction. The ALU 116 is capable of performing a limited set of operations relative to the ALUs of the processor cores 102, 104, 106, 108, thus making the ALU 116 less complex to implement and, for example, more suited for an in-memory or near-memory implementation.

The execution unit 150 also includes a register file 118. The register file 118, includes indexed registers for holding data for load/store operations. Such load/store operations are directed to memory or intermediate values of ALU computations. A PIM instruction can move data between the registers 118 and memory 182, and it can also trigger computation on this data in the ALU 116.

The execution unit also includes a command buffer 122 that stores operands and opcodes of one or more PIM instructions. Such operands and opcodes may be referenced by a PIM instruction through use of a pointer that implements an index into the command buffer. In such examples, a PIM instruction issued by a core of the host processor 132 need not encode the actual operand or opcode but can, instead, include a pointer to the operand or opcode in the command buffer 122.

In the example of FIG. 1, the PIM execution unit 150 is included in a PIM-enabled memory device 180 having one or more DRAM arrays 182. In such an example, the PIM instructions direct the PIM execution unit 150 to execute operations (specified by an operator) on data (specified as an operand) stored in the memory device 180. For example, operators of PIM instructions can include load, store, and arithmetic operators. Operands of PIM instructions can include architectural PIM registers, memory addresses, and values from core registers or other core-computed values.

The ISA implemented by the host processor 132 in the example of FIG. 1 can define a set of architectural PIM registers (e.g., eight indexed registers) that hold data for use in execution of PIM instructions. In the example of FIG. 1, there is one PIM execution unit 150 per DRAM component (e.g., bank, channel, chip, rank, module, die, etc.). Thus, the memory device 180 includes multiple PIM execution units 150. PIM instructions issued from the processor cores 102, 104, 106, 108 can access data from DRAM by opening/closing rows and reading/writing columns (like conventional DRAM commands do).

In an implementation, the host processor 132 issues PIM instructions to the ALU 116 of an execution unit 150. In implementations with a command buffer 122, the host processor 132 issues PIM instructions that include an index into an element of the command buffer 122 holding an operation to be executed by the ALU 116. In these implementations, the host-memory interface does not require modification with additional command pins to cover all the possible opcodes needed for PIM instruction execution.

An execution unit 150 can operate on a distinct subset of the physical address space. As such, each PIM instruction carries a target address that is used to direct it to the appropriate PIM unit or units. When a PIM instruction reaches the execution unit 150, it is serialized with other PIM instructions and memory accesses to DRAM targeting the same subset of the physical address space.

Each execution unit 150 is generally capable of faster access to data stored in memory relative to access of the same data by the host processor 132. In the example of FIG. 1, each execution unit is implemented as a component of a different memory bank 184. Readers of skill in the art will appreciate that various configurations of PIM modules and memory partitions (physical or logical) in a PIM-enabled memory device can be employed without departing from the spirit of the present disclosure. PIM-enabled memory devices can be double data rate (DDRx) memory, graphics DDRx (GDDRx) memory, low power DDRx (LPDDRx) memory, high bandwidth memory (HBM), hybrid memory cube (HMC), Non-Volatile Random Access Memory (NV-RAM), or other memory that supports PIM execution.

In the example system of FIG. 1, the host device 130 also includes a memory controller 140 that is shared by the processor cores 102, 104, 106, 108 for accessing various memory channels coupling the processor 132 to the memory device 180. The memory controller 140 is also used by the processor cores 102, 104, 106, 108 for offloading PIM instructions for execution by the PIM execution units 150. The memory controller 140 maintains one or more dispatch queues for queuing commands to be dispatched to a memory channel or other memory partition.

The host device 130 also includes a work scheduler 160. The work scheduler 160 provides multiple threads shared access to the resources of the PIM execution units 150. ‘Work,’ as the term is used here, generally refers to sets of PIM instructions to be executed by a PIM device. The work scheduler 160 reserves registers from the register file 118 of the execution unit 150 across threads actively dispatching work to the same execution unit 150 to ensure private storage per thread. In an implementation the work scheduler 160 reserves space in a command buffer 122 across threads of different processes actively dispatching work to the same execution unit 150. The work scheduler 160 intercepts requests to initiate execution of PIM instructions flowing from the processor cores 102, 104, 106, 108 to the memory controller 140, where they would otherwise be dispatched to the execution unit 150. Prior to dispatching any PIM instructions (or its constituent parts) to an execution unit 150, a thread dispatches a request to initiate execution of the PIM instructions on the execution unit. The thread also dispatches a command when the thread has completed offloading the PIM instructions to the execution unit 150. In a multithreaded application, each thread will perform the same set of operations as all other threads of the application when dispatching PIM instructions to the execution unit(s) 150.

In an implementation, the beginning and ending of a set of offloaded PIM instructions is marked by two special commands: a start of kernel command and an end of kernel command. Both commands are issued by a thread executing PIM instructions and are accompanied by the thread identifier and process identifier of the thread. The start of kernel command also carries information about the resources of the execution unit that are to be used by the PIM instructions to be offloaded. For example, the start of kernel command can specify the maximum number of registers used by the PIM instructions. The maximum number of registers can be defined by a library developer or by a compiler based on static analysis of the register lifetimes inside the PIM instruction code. Alternatively, this information can be omitted from the start of kernel command and the execution unit can reserve enough space to hold all architectural registers for a thread and process pairs upon receiving a start of kernel command.

In example the example of FIG. 1, such start of kernel and end of kernel commands are forwarded to the work scheduler 160 which manages the PIM resources at the host level before reaching any DRAM channels of the memory device 180. Both the start and end of kernel commands possess fence and barrier semantics that prohibit younger commands from being sent to the memory device 180 until an acknowledgement is received from the work scheduler 160. The PIM execution unit 150 reserves enough registers per thread from the register file 118 to guarantee correct execution of the entire set of PIM instructions included between the start and end of kernel commands. The registers are reserved by the work scheduler 160 upon receiving a start of kernel command and released with the end of kernel command. The start of kernel command prevents any PIM instructions from being dispatched by a thread until the work scheduler 160 confirms that PIM resources are available and reserved for the execution of the PIM instructions. Thus, in the case of an insufficient number of available PIM registers, a start of kernel command is queued in the work scheduler 160 and no confirmation is sent back to the processor core executing the thread that issued the start of kernel command.

Consider, for example, that every processor thread issues a start of kernel command before it starts dispatching PIM instructions to the work scheduler 160. The work scheduler 160 grants access to threads based on PIM resource availability and the PIM resource requirements specified in the start of kernel commands. The work scheduler only provides a grant response to the threads that have been granted access to PIM execution units. That is, the work scheduler only grants access to threads once resources have been reserved. All other threads wait for a response and do not dispatch any PIM instructions while waiting. The threads that are not waiting eventually issue an end of kernel command to the work scheduler 160 when they have completed dispatching a set of PIM instructions. The work scheduler 160 then releases the PIM resources for that thread, reserves resources for one or more threads that are pending in the queue, and grants access to those threads once the resources are reserved. This process continues until all threads have been granted access to the PIM execution units and dispatched all of their PIM instructions.

The work scheduler 160 can be a single logic block tracking PIM resource usage across all memory channels (i.e., DRAM channels). In other examples, the work scheduler can be logic physically distributed (address interleaved in a similar manner that DRAM channels are) among different physical partitions. The flow described above works for a centralized work scheduler 160 implementation with one queue, whereas a distributed work scheduler 160 implementation (with a local queue per work scheduler 160 block) requires each processor core to track the grant and response status from all physical partitions of the work scheduler 160. For example, for an SoC with 128 memory channels, the core would need a 128-wide bit vector for tracking grant/response status of each physical partition. Only when all physical partitions of the work scheduler 160 grant access to the thread is the thread allowed to dispatch PIM instructions to the PIM devices of all DRAM channels. In cases where a processor core itself supports multithreading, the processor core must track grant response statuses for each hardware context separately.

The work scheduler 160 can implement a number of dispatch policies to guarantee forward progress when dispatching work to execution units. In one example implementation that uses a single thread dispatch policy, only a single thread is granted access to the PIM execution units 150 of all memory channels at a time. The work scheduler 160 decides which thread to grant access using a policy such as a first-come-first-served policy, a per-process priority policy, and the like. To implement a policy, each PIM instruction must access physical addresses in the same DRAM row and column across all DRAM banks, ranks and channels. Since only one thread can be actively dispatching PIM instructions, the work scheduler 160 does not need to track PIM resources. It only needs to confirm that the thread's resource requirements can be met by each PIM execution unit.

Another example implementation uses a horizontal multithreaded dispatch policy in which multiple threads are allowed to dispatch work to all memory channels concurrently, so long as enough PIM execution unit resources are available. For example, two threads executing on two different processors can share the resources of each PIM unit as long as each PIM unit has enough resources to support execution of the PIM instructions of both threads. The work scheduler 160 in such an implementation tracks PIM execution unit resource utilization for all threads that have been granted access. A table in which PIM unit resources per thread are tracked can be sized to allow all or a subset of hardware contexts in the host device 130 to dispatch work to the PIM execution units.

Yet another example implementation uses a vertical multithreaded dispatch policy in which access to PIM execution units is granted to threads that dispatch work to fixed partitions of memory channels (as opposed to all memory channels). Consider an example where four threads T0, T1, T2, and T3 have been granted access to PIM execution units each using a fixed 2-channel partition. Threads T0 and T1 are dispatching PIM instructions to channels 0 and 1 only, where the PIM resources in channels 0 and 1 are shared by threads T0 and T1. Threads T2 and T3 are dispatching PIM instructions to channels 30 and 31 only, where the PIM resources in channels 30 and 31 are shared by threads T2 and T3. In this implementation, the channel partition size (i.e., 2) is the same across all threads. A physically distributed implementation of a work scheduler must ensure a table per channel partition. Moreover, if the work scheduler 160 is physically distributed, each processor core must track grant/response status for every channel partition. A centralized work scheduler 160 implementation must track reserved PIM resources per thread and per channel partition.

In another implementation, the size of the memory channel partition varies per thread. Consider an example where T0 can dispatch PIM instructions to all 32 channels, while T1 dispatches work to a 2-channel partition (e.g., channels 0 and 1) and T2 dispatches PIM instructions to a different 4-channel partition (e.g., channels 2-5). A physically distributed work scheduler 160 must ensure a table per minimum size channel partition while the processor core must track grant/response status for the minimum channel partition supported. A centralized work scheduler implementation must be able to track reserved PIM resources per thread and per minimum size channel partition.

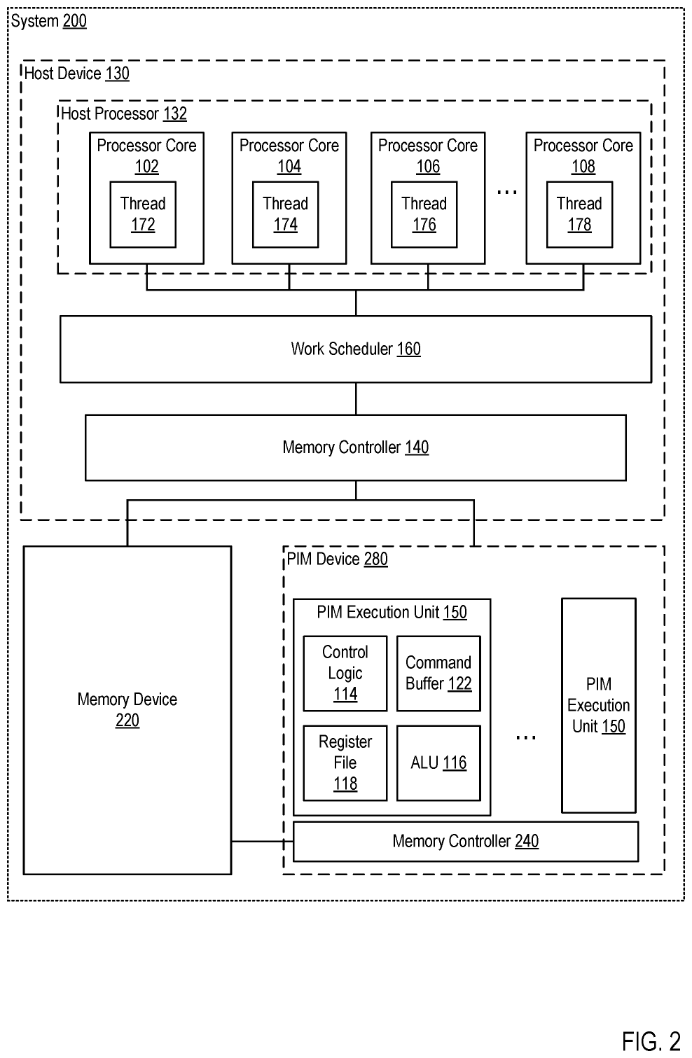

For further explanation, FIG. 2 sets forth a block diagram of another example system 200 for supporting PIM execution in a multiprocessing environment in accordance with the present disclosure. The system of FIG. 2 is similar to the system in FIG. 1 except that, in the system of FIG. 2, a PIM device is not implemented as a component of a memory device. Instead, the PIM device 280 of FIG. 2 is implemented as a stand-alone component separate from both the host processor 132 and a memory device 220. The PIM device 280 includes a memory controller 240 coupled to a memory device 220. The host processor 132 and the PIM device 280 are both coupled to the same memory device 220. The host processor 132 provides PIM instructions to the PIM device 280 through the memory controller 140. The execution unit 150 of the PIM device then 280 executes the PIM instructions using data stored in the memory 220. In an implementation, the PIM device 280 can be implemented in the interface die of a 3-D stacked memory device or as a separate die entirely. Being closely coupled to a memory device and separate from the processor 132, the PIM device 280 in the example of FIG. 2 is said to be ‘near’ memory.

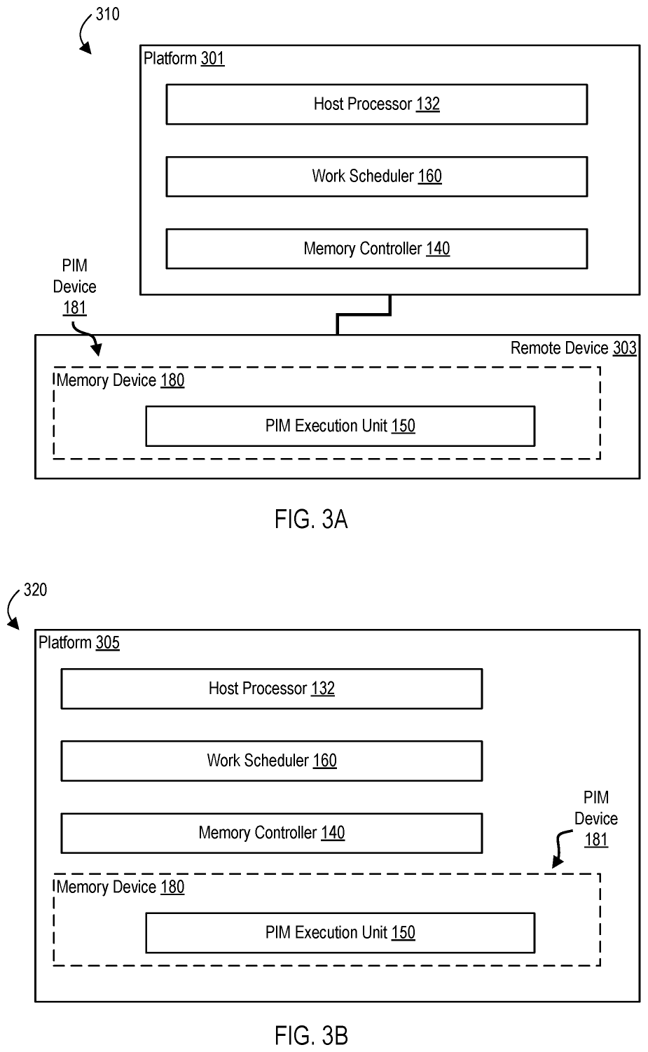

For further explanation, FIG. 3A and FIG. 3B each set forth a block diagram of an example implementation of a system for supporting PIM execution in a multiprocessing environment according to an implementation of the present disclosure. In the example system 310 of FIG. 3A, a memory controller 140, a work scheduler 160, and a host processor 132 and are implemented in the same System-on-Chip (SoC) platform 301. A PIM device 181, formed of a PIM execution unit 150 and a memory device 180, is implemented in a remote device 303.

In the example system 320 of FIG. 3B, the PIM device 181, formed of a memory device 180 PIM and a PIM execution unit 150, is implemented along with the memory controller 140, the work scheduler 160, and the host processor 132 as part of the same SoC platform 305. Although the PIM device 181 is implemented on the same SoC platform 305 as the host processor 132, it is noted that the PIM device 181 is considered to be external to the host processor 132 in that logic circuitry that implements the PIM device is external to logic circuitry that implements any processor core of the host processor 132.

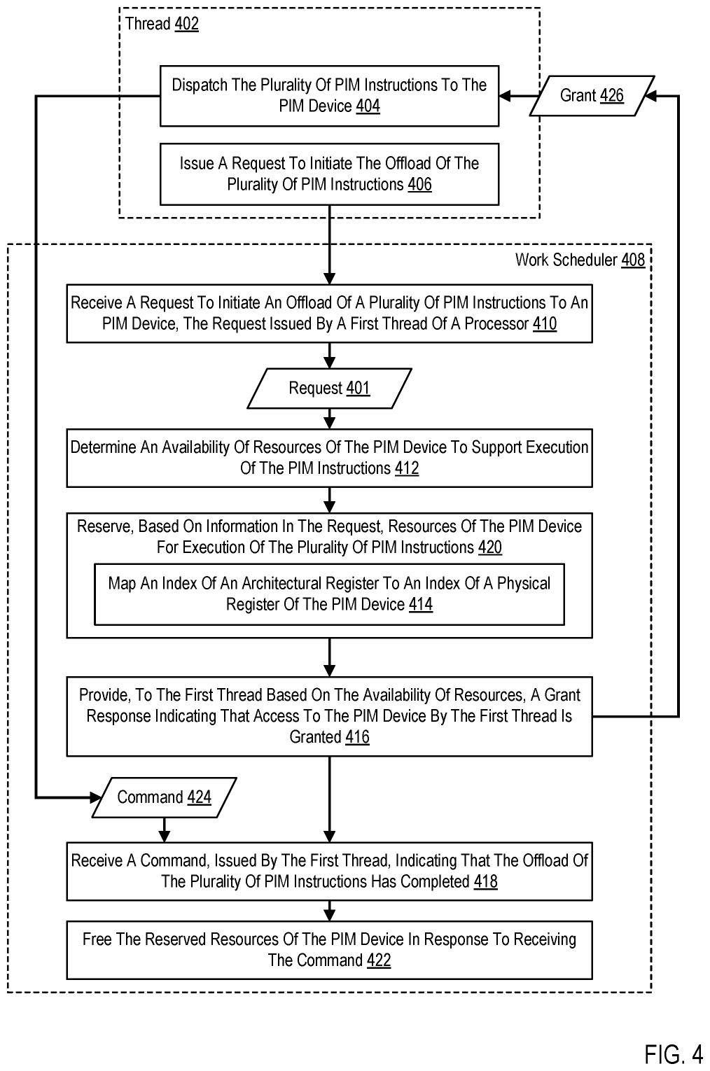

For further explanation, FIG. 4 sets forth a flow chart illustrating an example method for supporting PIM execution in a multiprocessing environment according to an implementation of the present disclosure. The example method of FIG. 4 can be carried out in any of the systems of FIG. 1, 2 or 3. The method of FIG. 4 includes issuing 406, by the first thread 402, a request 401 to initiate an offload of a plurality of PIM instructions. During executing of application instructions, the thread 402 generates one or more commands for directing a PIM execution unit to execute the PIM instruction. The request 401 includes an identifier such as the processor identifier or thread identifier of the thread. The request 401 also includes a resource requirement that specifies, for example, a quantity of registers, a quantity of command buffer space, a quantity of scratchpad memory space, or any combination. A scratchpad memory can be a memory structure arranged in blocks or ranges of address such as a 1 kilobyte (KB) block, that can be utilized temporarily by an executing PIM instruction. The example of FIG. 4 is directed to PIM instructions executed by a single thread 402 for purposes of clarity, rather than limitation. Additional examples in which multiple threads execute PIM instructions and share PIM resources are described below with respect additional figures.

The method of FIG. 4 continues by a work scheduler 408 receiving 410 the request 401 to initiate the offload of the plurality of PIM instructions to a PIM device. The work scheduler 408, in an implementation, receives 410 the request 401 in the form of a start of kernel command described above. This request indicates to the work scheduler that the thread will begin dispatching PIM instructions. The request includes the process identifier and thread identifier of the thread and functions as a request to reserve resources of the PIM execution unit.

The method of FIG. 4 also includes determining 412 an availability of resources of the PIM device to support execution of the PIM instructions. Determining 412 the availability of resources of the PIM device is carried out by, initially, identifying a resource requirement for the set of PIM instructions to be offloaded to the execution unit. The resource requirement is explicitly stated in the request 401 as discussed above. For example, the request can indicate the number of registers used by the set of PIM instructions, the number of entries of a command buffer needed to store the operations of a set of PIM instructions, the number of blocks of scratchpad memory as discussed above and other specific requests for resources as will occur to readers of skill in the art. In other examples, the resource requirement is inferred by the work scheduler. For example, if no resource requirement is explicitly stated, the work scheduler can infer that the number of registers required is equal to the total number of architectural registers.

Determining 412 the availability of resources can also be based on an allocation of resources to other active threads. In an implementation, allocation tables can be used to track the different resources of PIM execution units that have been allocated to threads. For example, an entry in an allocation table includes the PID/TID of the thread, the number of registers allocated, the number of command buffer entries allocated, and the number of scratchpad blocks allocated. In an example in which a PIM execution unit includes a register file of 16 registers and 14 registers have already been allocated to other threads, then 2 registers are available for reservation by the work scheduler. Once the availability of resources is determined the work scheduler 408 can also determine whether the available resources meet the resource requirements of the first thread. Continuing the example, if the first thread requires only two registers, then there are sufficient available registers to support execution of the set of PIM instructions to be offloaded.

Once the work scheduler 408 determines 412 that there are available resources to support execution of the PIM instructions, the method of FIG. 4 continues by reserving 420 resources of the PIM device for execution of the PIM instructions. The work scheduler 408 reserves 420 resource by virtually allocating resources of the PIM execution unit to the thread, which are held available for use by the PIM instructions until the PIM instructions complete. In these examples, the work scheduler does not assign physical resources but instead tracks what resources have been requested by various threads that are still active with respect to the PIM execution unit. At system initialization, the work scheduler identifies the total usable resources of the execution and virtually allocates resources by decrementing the total usable resources when requested by a thread and incrementing the total usable resources when released by a thread. For example, when a thread requires two registers of the PIM execution unit to execute the set of PIM instructions to be offloaded, the work scheduler decrements the number of available registers by two. When the thread releases the registers at the completion of the PIM instructions, the work scheduler increments the number of available threads by two. In these examples, the virtual allocation of resources is tracked based on an identifier included in the request 401 to initiate the offload of operations (such as the PID or TID of the thread including the PIM instructions). Based on the resource requirements included in the request, the work scheduler 408 virtually allocates resources to the thread by associating the PID/TID of the thread with a quantity of resources (e.g., number of registers, number of lines in the command buffer, amount of memory in the scratchpad) that have been requested by the thread and will be assigned by the PIM execution unit. Such an association can be made in a table or similar data structure.

In the example of FIG. 4 reserving 410 resources of the PIM device also includes mapping 414 an index of an architectural register to an index of a physical register of the PIM device. Mapping 414 such an index is carried out by the PIM device receiving a command that references a register index of an architectural register (such as a register for operands of PIM instructions) and mapping the architectural register index to a physical register index of the PIM device. The PIM device then associates the mapping with an identifier of the thread (e.g., the PID/TID) that issued the command. In one example implementation, the PID/TID is assigned an offset such that the indices of architectural registers in PIM instructions are mapped to indices of physical registers by adding the offset to the index of each architectural register.

Consider an example of a kernel of PIM code where two threads T0 and T1 execute the same kernel that uses two PIM architectural registers:

PIMLoad PIMReg0, [PA0]

PIMAdd PIMReg0, PIMReg0, x

PIMMul PIMReg1, PIMReg0, y

PIMSub PIMReg1, PIMReg1, z

PIMStore [PA1], PIMReg1

When threads T0 and T1 send a start of kernel command to a PIM device via the work scheduler, the start of kernel commands will specify that two PIM registers need to be reserved. Thus, the PIM device will reserve a total of four physical PIM registers (two registers for thread T0 and two registers for thread T1) while executing PIM instructions from both threads T0 and T1.

Assume also that the start of kernel command from T0 arrives ahead of the start of kernel command from T1 at the PIM device. Each command sent by the threads T0 and T1 to the PIM device also communicates the PID/TID of the sending thread to the PIM device via, for example, a data bus. Thus, the PID/TID of thread T0 is associated with an offset of ‘0’ and the PID/TID of the thread T1 is associated with an offset of ‘2’ (because two registers have already been reserved for thread T0). When a command for a PIM instruction from T0 is issued by the host memory controller, the PIMReg0 and PIMReg1 indices will be used with an offset of 0 by the PIM device before indexing the PIM register. When the same command is issued by the host memory controller for T1, both PIMReg0 and PIMReg1 indices will be remapped with an offset of 2. The offset is selected by the PID/TID communicated to the PIM device along with the command issued by the host. That is, the architectural registers PIMReg0 and PIMReg1 in the PIM instructions from thread T0 are mapped to physical PIM register file entries 0 and 1 while the architectural registers PIMReg0 and PIMReg1 in the PIM instructions from thread T0 are mapped to physical PIM register file entries 2 and 3.

In another example implementation, mapping the architectural register index to a physical register index of the PIM device is carried out using register renaming. For example, a mapping table is indexed by the PID/TID of the thread and the architectural PIM register index. A physical register index is mapped to the architectural register index for the PID/TID of the thread in the mapping table. Register renaming logic in the PIM device assigns and releases physical registers on demand. A completion command, such as an end of kernel command, from the thread releases all architectural registers and physical registers from a PID/TID of the thread by removing the entry for the PID/TID of the thread from the mapping table.

At a time after the work scheduler 408 reserves 420 the resources of the PIM device for execution of the PIM instructions, the work scheduler 408 then provides 416 a grant response 426 to the first thread 402 indicating that the first thread is granted access to the PIM device. The grant response 426 functions as an acknowledgment that the requested resources are available and have been reserved for the thread, such that the PIM device can support execution of the set of PIM instructions from the thread 402. In these examples, the thread will not begin dispatching 404 the PIM instructions until the grant response has been received.

Once the PIM instructions of the thread 402 are dispatched to the PIM device for execution and execution is completed, the method of FIG. 4 continues by receiving 418 a command indicating that the offload of the plurality of PIM instructions has completed. Such a command 424 is received by the work scheduler 408 from the thread dispatching the PIM instructions to the PIM device. That is, the thread 402 issues an end of kernel command to the work scheduler 408 as means to notify the work scheduler that the resources of the PIM device that were previously reserved for execution of the thread's PIM instructions are no longer needed by the thread.

To that end, the work scheduler 408 then frees 422 the reserved resources of the PIM device in response to receiving the command. The work scheduler 408 frees the resources by identifying the PID/TID of the thread from the completion command 424 and removing associations of the PID/TID with resources of the execution unit. In an implementation, entries in an assignment table that include the PID/TID of the thread are removed. For example, if register index 1 of the execution unit is assigned to thread T1, the PID/TID of thread T1 is removed from the assignment table entry for register index 1.

The work scheduler 408 can also free 422 the reserved resources that have been virtually allocated to the thread. The work scheduler 408 identifies the PID/TID of the thread from the completion command 424 and removes an allocation of resources that is associated with the PID/TID. In an implementation, entries in an allocation table that include the PID/TID of the thread are removed. For example, if thread T1 has been allocated two registers of the execution unit, and entry indicating that thread T1 is using two registers is removed from the allocation table and the available register count for the execution unit is incremented by two.

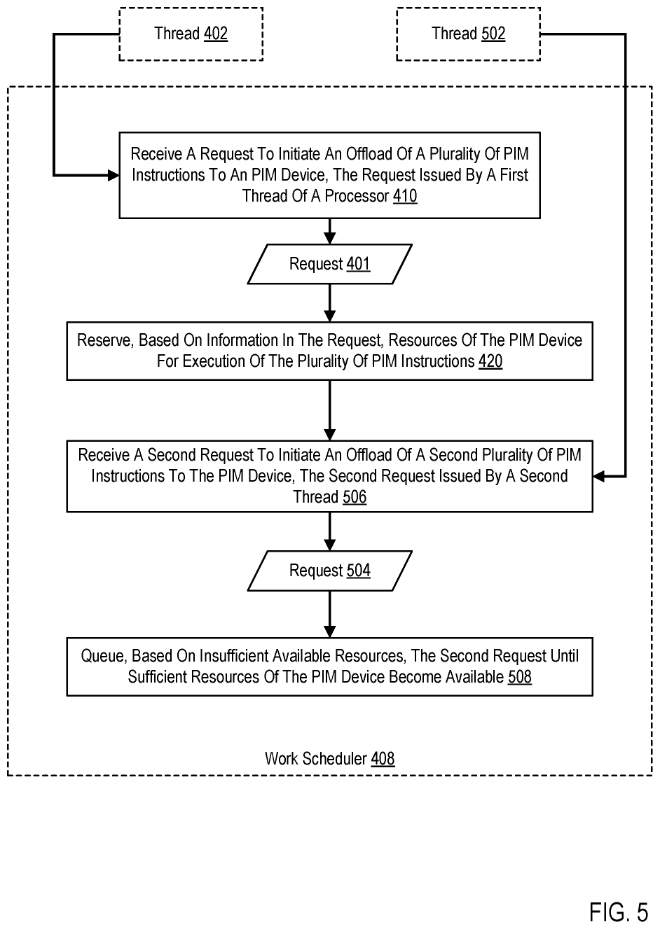

As mentioned above, the example of FIG. 4 is depicted with a single thread for purposes of clarity of explanation, not limitation. For further explanation, FIG. 5 sets forth a method of supporting PIM execution in a multiprocessing environment in which multiple threads are executing concurrently according to implementations of the present disclosure. In in implementations in which multiple threads execute concurrently and share PIM execution resources, the work scheduler 408 operates similar as described above with respect to FIG. 4. That is, the work schedule reserves available resources of a PIM device upon a request from a first thread 402 for execution of the first thread's PIM instructions.

In the example of FIG. 5, however, the work scheduler 408 also receives 506 a second request 504 to initiate an offload of a second plurality of PIM instructions to the PIM device. The second request 504 is issued by a second thread 502. In implementations in which the first thread 402 has not completed PIM instruction execution, the work scheduler 408 has not freed the resources reserved for execution of those PIM instructions. In examples in which the available resources at that time does not satisfy the second thread's request 504 for, there are insufficient available resources for execution of the second thread's 502 PIM instructions. In such an example, the work scheduler 408 queues 508 the second request 504 until sufficient resources of the PIM device become available.

In an implementation, the work scheduler 408 receives a completion command from another thread, frees the resources utilized by that thread and can then proceed with reserving 410 resources of the PIM device for the queued request 504 of the second thread 502. The work scheduler withholds a grant response to the request 504 to the second thread until those resources become available. By withholding such an acknowledgement, the thread 502 is made aware that the request has been queued. Thus, the second thread will not issue the commands for the set of PIM instructions until the grant response is received and the dispatch queues that would normally hold such commands will not become full. When such queues become full, PIM execution can become deadlocked because a completion command from a thread that is currently executing PIM instructions cannot be queued in the work scheduler and resources cannot be freed. To ensure that such a deadlock does not occur, the dispatch queue includes commands for PIM instructions of threads for which resources of the PIM device have been reserved and all other threads withhold commands until a grant response is received.

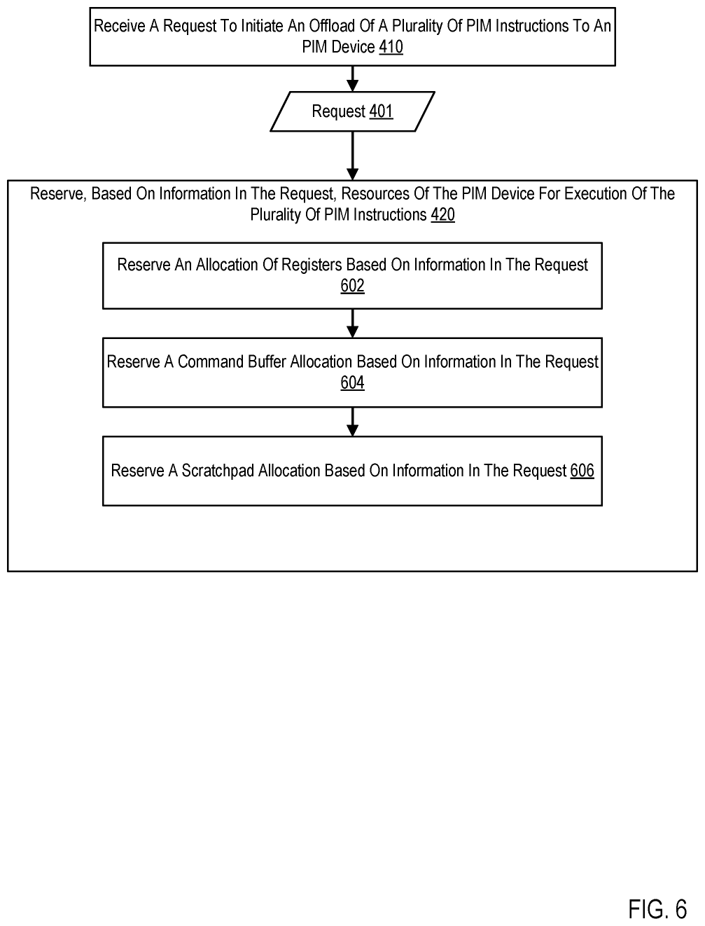

PIM Resources of various types can be reserved for use by threads in executing PIM instructions. To that end, the FIG. 6 sets forth a flow chart illustrating the reservation of several different types of PIM resources according to implementations of the present disclosure. The method of FIG. 6 includes reserving 602 an allocation of registers based on information in the request (the request 401 from a thread to reserve PIM resources). As mentioned above, a request 401 to reserve resources for PIM execution, in an implementation, includes a specification of a number of registers to reserve. For example, a start of kernel command for a set of PIM operations to be executed on the PIM unit specifies that the PIM instructions will require a maximum number of N registers. The maximum number of registers can be defined either by a programmer prior to compiling the code through or by the compiler based on static analysis of the register lifetimes inside the instruction sequence. Mapping and remapping of architectural registers indexes to the physical register of the PIM execution unit as described above can be performed by execution unit itself.

The method of FIG. 6 also includes reserving 604 a command buffer allocation based on information in the request. The request 401 can specify a number of instructions in the set of PIM instructions that will be written to the command buffer. This determines the amount of space (e.g., indices 0-7) in the command buffer that will be required to offload the operations. For example, a start of kernel command for a set of PIM instructions specifies the number of lines of PIM instructions in the PIM instruction code. The number of lines can be determined by a compiler based on static analysis of the instruction sequence.

The command buffer allocation can be carried out by mapping command buffer elements to a particular PID or TID of a thread requesting the allocation of the command buffer. The mapping and remapping of command buffer allocation is performed by the memory controller. For example, the memory controller uses the start of kernel and end of kernel commands to reserve and release command buffer space in the command buffer by tracking command buffer indices to which the memory controller has written a set of offloaded operations for a particular PID/TID and marking those indices as invalid when the end of kernel command from the same PID/TID is received. When a new start of kernel command is received, the memory controller writes new instructions into the invalid indices of the command buffer. However, if the new thread uses the same set of PIM instructions as the previous thread, the memory controller needs only to associate those command buffer indices with the PID/TID of the new thread.

The method of FIG. 6. also includes reserving 606 a scratchpad allocation based on information in the request. The request 401 can specify a maximum number of blocks of scratch pad memory that will be utilized by the PIM instructions for execution. A start of kernel command, for example, for a set of PIM instructions to be executed on the PIM device specifies that the PIM instructions will require a maximum number of M blocks of scratchpad memory. The maximum number of blocks of scratchpad memory can be defined by a programmer prior to compiling of the PIM code. The PIM execution device can allocate the blocks or addresses specified by the work scheduler in the reservation by associating blocks or addresses of scratch pad memory to a PID/TID of a thread.

Although three different forms of resources are described as being reserved in the example of FIG. 6, readers of skill in the art will recognize that any number and type of PIM resource can be reserved in accordance with implementation in this disclosure. That is, in addition to the three types of resources described in FIG. 6 there are plurality of other types that can be reserved. In addition, any number of resources can be reserved as part of satisfying a single request 401. That is, a request can specify all, none, or any combination of the available PIM resources needed for execution of PIM instructions. Likewise, the work scheduler when initiating the reservation 420 of such requested resources can carry out the reservations in any order.

Implementations can be a system, an apparatus, a method, and/or logic. Computer readable program instructions in the present disclosure can be implemented as assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In an implementation, electronic circuitry including, for example, programmable logic circuitry, field-programmable gate arrays (FPGA), or programmable logic arrays (PLA) may execute the computer readable program instructions by utilizing state information of the computer readable program instructions.

Aspects of the present disclosure are described herein with reference to flowchart illustrations and/or block diagrams of methods, apparatus (systems), and logic circuitry according to an implementation of the disclosure. It will be understood that each block of the flowchart illustrations and/or block diagrams, and combinations of blocks in the flowchart illustrations and/or block diagrams, can be implemented by logic circuitry.

The logic circuitry may be implemented in a processor, other programmable data processing apparatus, or other device to cause a series of operational steps to be performed on the processor, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and logic circuitry according to various implementations of the present disclosure. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

While the present disclosure has been particularly shown and described with reference to implementations thereof, it will be understood that various changes in form and details may be made therein without departing from the spirit and scope of the following claims. Therefore, the implementations described herein should be considered in a descriptive sense only and not for purposes of limitation. The present disclosure is defined not by the detailed description but by the appended claims, and all differences within the scope will be construed as being included in the present disclosure.

What is claimed is:

1. A processor for supporting PIM (Processing-in-Memory) execution in a multiprocessing environment, the processor comprising logic configured to:
receive a request to initiate an offload of a plurality of PIM instructions to a PIM device, the request issued by a first thread of a processor; and
reserve, based on information in the request, resources of the PIM device for execution of the plurality of instructions.

2. The processor of claim 1 further comprising logic configured to:
determine an availability of resources of the PIM device to support execution of the PIM instructions; and
provide, to the first thread based on the availability of resources, a grant response indicating that access to the PIM device by the first thread is granted.

3. The processor of claim 2 further comprising logic configured to:
receive a second request to initiate an offload of a second plurality of PIM instructions to the PIM device, the second request issued by a second thread; and
queue, based on insufficient available resources, the second request until sufficient resources of the PIM device become available.

4. The processor of claim 2 further comprising logic configured to:
issue, by the first thread, the request to initiate the offload of PIM instructions; and
dispatch, by the first thread, the PIM instructions to the PIM device only after the grant response is received.

5. A method of supporting PIM (Processing-in-Memory) execution in a multiprocessing environment, the method comprising:
receiving a request to initiate an offload of a plurality of PIM instructions to a PIM device, the request issued by a first thread of a processor; and
reserving, based on information in the request, resources of the PIM device for execution of the plurality of PIM instructions.

6. The method of claim 5 further comprising:
receiving a command, issued by the first thread, indicating that the offload of the plurality of PIM instructions has completed; and
freeing the reserved resources of the PIM device in response to receiving the command.

7. The method of claim 5, wherein reserving, based on information in the request, resources of the PIM device for execution of the plurality of PIM instructions includes:
reserving an allocation of registers based on information in the request.

8. The method of claim 5, wherein reserving, based on information in the request, resources of the PIM device for execution of the plurality of PIM instructions includes:
reserving a command buffer allocation based on information in the request.

9. The method of claim 5, wherein reserving, based on information in the request, resources of the PIM device for execution of the plurality of PIM instructions includes:
reserving a scratchpad allocation based on information in the request.

10. The method of claim 5 further comprising:
determining an availability of resources of the PIM device to support execution of the PIM instructions; and
providing, to the first thread based on the availability of resources, a grant response indicating that access to the PIM device by the first thread is granted.

11. The method of claim 10 further comprising:
receiving a second request to initiate an offload of a second plurality of PIM instructions to the PIM device, the second request issued by a second thread; and
queuing, based on insufficient available resources, the second request until sufficient resources of the PIM device become available.

12. The method of claim 10 further comprising:
issuing, by the first thread, the request to initiate the offload of the plurality of PIM instructions; and
dispatching, by the first thread, the plurality of PIM instructions to the PIM device only after the grant response is received.

13. The method of claim 12, wherein the first thread dispatches the plurality of PIM instructions to a set of memory channels concurrently with at least one second thread dispatching PIM instructions to that set of memory channels.

14. The method of claim 12, wherein the first thread dispatches the plurality of PIM instructions to a first partition of memory channels concurrently with at least one second thread dispatching PIM instructions to a second partition of memory channels.

15. The method of claim 5, wherein reserving, based on information in the request, resources of the PIM device for execution of the plurality of PIM instructions includes:
mapping an index of an architectural register to an index of a physical register of the PIM device.

16. The method of claim 5 wherein the PIM device is included in a memory device.

17. A system for supporting PIM (Processing-in-Memory) execution in a multiprocessing environment, the system comprising:
a memory device, the memory device comprising a PIM device for executing PIM instructions; and
a multicore processor coupled to the memory device, the processor comprising logic configured to:
receive a request to initiate an offload of a plurality of PIM instructions to the PIM device, the request issued by a first thread of the processor; and
reserve, based on information in the request, resources of the PIM device for execution of the plurality of PIM instructions.

18. The system of claim 17, wherein the processor further comprises logic configured to:
determine an availability of resources of the PIM device to support execution of the PIM instructions; and
provide, to the first thread based on the availability of resources, a grant response indicating that access to the PIM device by the first thread is granted.

19. The system of claim 18, wherein the processor further comprises logic configured to:
receive a second request to initiate an offload of a second plurality of PIM instructions to the PIM device, the second request issued by a second thread of the processor; and
queue, based on insufficient available resources, the second request until sufficient resources of the PIM device become available.

20. The system of claim 18, wherein the processor further comprises logic configured to:
issue, by the first thread, the request to initiate the offload of the plurality of PIM instructions; and
dispatch, by the first thread, the plurality of PIM instructions to the PIM device only after the grant response is received.
